(19) United States
(12) Patent Application Publication
(10) Pub. No.: US 2014/0129444 A1
(43) Pub. Date: May 8, 2014

(54) SERVICE LEVEL AGREEMENT CONTRACT CREDIT VALIDATION

(71) Applicant: VERIZON PATENT AND LICENSING INC., Arlington, CA (US)

(72) Inventor: Justin K. LeRoy, Rockville, MD (US)

(73) Assignee: VERIZON PATENT AND LICENSING INC., Arlington, VA (US)

(21) Appl. No.: 13/670,971

(22) Filed: Nov. 7, 2012

(51) Int. Cl. G06Q 20/14

(52) U.S. Cl. CPC G06Q 20/14
USPC 705/44

(57) ABSTRACT

A service level agreement validation device may, upon receiving a service level agreement credit request from a customer, identify a type of the service level agreement credit request; validate the service level agreement credit request based on the type of the service level agreement credit request; update a disposition of the service level agreement credit request based on result of the validation; and selectively provide a credit to the customer based on the disposition of the service level agreement credit request. The service level agreement validation device may further provide credit refunds to the customer for service level agreement credit requests determined to be valid.

### BACKGROUND

A service provider may provide communications services to a customer, where the service provider and customer define the level of communications services being provided in a service contract. This service contract may be referred to as a service level agreement (SLA). The SLA may specify aspects of the quality of the service to be provided to the customer, such as mean time between failures (MTBF), mean time to repair or mean time to recovery (MTTR), data rates, throughput, jitter, overall uptime guarantees, and consequences of failing to meet these requirements.

From time to time, the customer may call to request a billing credit based on a perceived issue with the provided communications services. For instance, the service provider may fail to meet the terms of the SLA, and the customer may call to report the deficiency. In other instances, a customer may call to request a credit but may not be entitled to the credit. These and other customer requests may complicate billing and support functions of the service provider.

### BRIEF DESCRIPTION OF THE DRAWINGS

FIG. 1 illustrates an exemplary system configured to process SLA credit requests.

FIG. 2 illustrates an exemplary process for receiving SLA credit requests.

FIG. 3 illustrates an exemplary process for identifying a type of SLA credit request for validation.

FIG. 4 illustrates an exemplary process for validating on-time provisioning SLA credit requests.

FIG. 5 illustrates an exemplary process for validating service-specific SLA credit requests.

FIG. 6 illustrates an exemplary process for validating service outage and time-to-restore SLA credit requests.

FIG. 7 illustrates an exemplary process for providing credit refunds to customers based on validated SLA credit requests.

FIG. 8 illustrates an exemplary customer SLA credit request summary report.

FIG. 9 illustrates an exemplary disposition SLA credit request summary report.

FIG. 10 illustrates an exemplary SLA credit request processing summary report.

FIG. 11 illustrates an exemplary SLA credit request disposition summary report.

### DETAILED DESCRIPTION

A customer may be billed for communications services rendered, with appropriate adjustments for any service issues tracked by the service provider. For example, credits may be refunded to the customer based on an amount of time that a service may have been unavailable. A customer may have called in a trouble ticket, thereby starting a clock for repair time to be credited back to the customer. The service provider may accordingly begin work on the trouble ticket. The service provider may fix the issue, confirm the status of the service with the customer, close the ticket, and stop the credit clock. The SLA contract may specify that the customer is to be credited for the time accrued by the repair clock. Downward adjustments to the credit clock may be made based on time the service provider may wait for the customer, such as waiting for the customer to power up the troubled equipment or waiting for the customer to confirm the repaired status. In some instances, the customer may believe that it is entitled to a credit that did not appear on the billing statement according to the terms of the SLA.

A system may be configured to automate processing such billing issues related to customer-reported SLA issues. The system may be configured to receive data from completely unrelated and previously uncoupled sources, including issue tracking databases as well as billing databases, and to verify the data from the sources to facilitate the handling of credit requests. The system may further be configured to receive and automatically act on customer requests for billing credits. These requests may be based on perceived issues with the billing for provided communications services relating to the terms defined in a SLA associated with the customer. The system may further be configured to act on the requests by validating these requests to determine whether a credit is warranted and providing reports to the customers indicating the status of any applied credits as well as reports to management of the service provider with respect to the status of the SLA and associated billing.

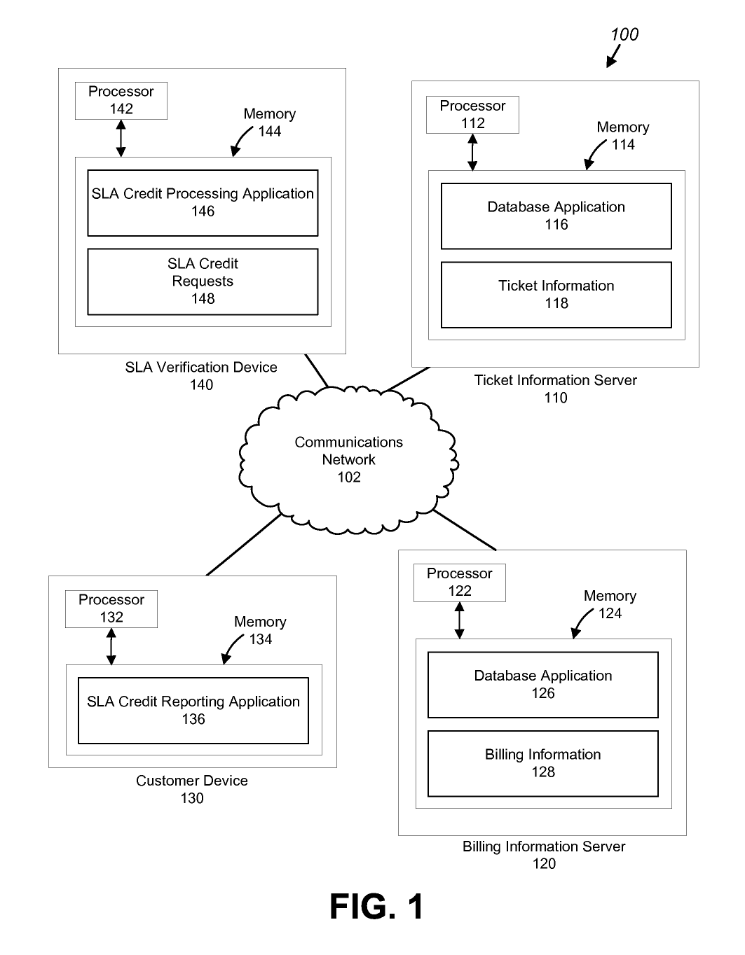

FIG. 1 illustrates an exemplary system 100 configured to automate the processing of customer reported SLA credit requests 148. The system 100 may include a ticket information server 110, a billing information server 120, and a customer device 130 in communication with a SLA verification device 140 over a communications network 102. The servers and devices in turn include hardware and software in support of the processing of SLA credit requests 148. More specifically, the ticket information server 110, billing information server 120, customer device 130 and SLA verification device 140 may respectively include processors 112, 122, 132, and 142 that execute instructions stored on memories 114, 124, 134 and 144. The memory 114 of the ticket information server 110 may store ticket information 118 as well as a database application 116 that may be constructed from program code and executable by the processor 112. The memory 124 of the billing information server 120 may store ticket information 118 as well as a database application 126 executable by the processor 122. The memory 134 of the customer device 130 may store a SLA credit reporting application 136 constructed from program code and executable by the processor 132. The memory 144 of the SLA verification device 140 may store SLA credit requests 148 as well as a SLA credit processing application 146 that may be constructed from program code and executable by the processor 142. The customer devices 130 may be configured to submit SLA credit requests 148 for processing by the SLA verification device 140, and may receive reports from the SLA verification device 140 based on the SLA credit requests 148. The SLA verification device 140 may be configured to verify the SLA credit requests 148 utilizing the ticket information server 110 and the billing information server 120. The system 100 may take many different forms and include multiple and/or alternate components and facilities. While an exemplary system 100 is shown in FIG. 1, the exemplary components illustrated of the system 100 are not intended to be limiting. Indeed, additional or alternative components and/or implementations may be used.

The communications network 102 may be configured to transport data between devices on the communications network 102. For instance, the communications network 102 may provide communications services, including packet-switched network services (e.g., Internet access, VoIP communication services) and circuit-switched network services (e.g., public switched telephone network (PSTN) services) to devices connected to the communications network 102. Exemplary communications networks 102 may include the PSTN, a VoIP network, a cellular telephone network, a fiber optic network, and a cable television network. To facilitate communications, communications devices on the communications network 102 may be associated with unique device identifiers being used to indicate, reference, or selectively connect to the identified device on the communications network 102. Exemplary device identifiers may include telephone numbers, mobile device numbers (MDNs), common language location identifier (CLLI) codes, internet protocol (IP) addresses, input strings, and universal resource identifiers (URIs).

The ticket information server 110 may be configured to execute a database application 116 configured to cause the ticket information server 110 to maintain ticket information 118 related to the status of issues related to the functioning of the communications network 102. In some cases, these issues may be reported by customers, while in other cases, these issues may be reported from other sources, such as automatically by the communications network 102 due to scheduled network outages or automatically identified network problems. Exemplary ticket information 118 may include information such as: ticket open date; ticket open time; ticket closed date; ticket closed time; ticket outage minutes; ticket priority; outage cause; issue resolution; and account number. The ticket information server 110 may be configured to receive the ticket information 118, and to utilize the database application 116 to incorporate the received ticket information 118 into the memory 114 or into another data store. The ticket information server 110 may further utilize the database application 116 to allow for selective querying and updating of the stored ticket information 118.

The billing information server 120 may be configured to execute a database application 126 configured to cause the billing information server 120 to maintain billing information 128 related to billing for services rendered to customers of the service provider. To facilitate billing, in some cases the memory 124 of the billing information server 120 may include SLA information and billing information 128 based on the SLA of an associated customer. The billing information server 120 may be further configured to receive billing information 128 relating to customer usage of communications services. The billing information server 120 may further utilize the database application 116 to further allow for selective querying of the billing information 128 to provide billing statements and other account information of the customers.

In some cases, the customer may believe that it is entitled to a credit that did not appear on the billing statement according to the terms of the SLA. The customer may make this request to the service provider as a SLA credit request 148. The customer device 130 may be configured to utilize a SLA credit reporting application 136 to allow customers to submit SLA credit requests 148 and to receive responses based on the SLA credit requests 148. For example, the SLA credit reporting application 136 may provide a form that may be used by customers to fill in information to include in the SLA credit request 148. As another example, the SLA credit reporting application 136 may include a web browser application configured to display web content to be used by customers to fill in information to include in the SLA credit request 148. As yet a further example, the SLA credit reporting application 126 may include an e-mail application configured to allow the use to submit SLA credit request 148 by e-mail. Exemplary customer devices 130 may include mobile phones, tablet computers, personal computers, or any other computing device capable of executing the SLA credit reporting application 136 and sending the SLA credit requests 148 to the SLA verification device 140 over the communications network 102.

The SLA credit request 148 may include information such as: submitter contact information (e.g., submitter name, submitter phone number, submitter e-mail address); SLA identifier; type of SLA credit request (e.g., service outage SLA credits (SO credits), time-to-restore (TTR) SLA credits (TTR credits), on-time provisioning SLA credits (OTP credits), and service-specific SLA credits (SS credits)); trouble ticket number for TTR type and SO type requests; order number for OPT type requests; and service type, bureau/agency and reporting month for SS type requests. As discussed in detail below, the processes for validation of whether the customer is owed a refund vary according to the credit type of the SLA credit request 148.

The SLA verification device 140 may be configured to receive and process SLA credit requests 148. In some examples, the SLA verification device 140 may be configured to utilize a SLA credit processing application 146 executed by the processor 142 of the SLA verification device 140 to perform some or all of the operations of the SLA verification device 140 discussed herein. For example, the SLA verification device 140 may be configured to process SLA credit requests 148 received from the customer device 130. Responsive to the customer request, the SLA verification device 140 may be further configured to return a notification to the customer that the SLA credit request 148 was received.

The SLA verification device 140 may be further configured to process the SLA credit request 148 to determine whether the customer is entitled to a credit. To facilitate the processing, the SLA verification device 140 may maintain SLA credit requests 148 including information related to the SLA credit request 148. The maintained SLA credit requests 148 may include fields related to a reported issue (e.g., information similar to that discussed above with respect to the submitted SLA credit request 148). The maintained SLA credit requests 148 may further include fields related to tracking the processing of the SLA credit request 148, fields related to timing of the disposition of the SLA credit request 148, and fields related to an amount of credit owed to the customer according to the SLA credit request 148.

Exemplary fields related to the processing of the SLA credit request 148 may include: a unique tracking number for the issue; a field indicative of the disposition of the issue (e.g., “Credited”, “Not Eligible”); a field indicative of whether the issue is “Open” or “Closed”, a field indicative of the type of SLA credit request 148 (e.g., SO type, TTR type, OTP type, SS type); a justification for the disposition of the SLA credit request 148 (e.g., “Does not meet TTR criteria”, “Ticket>6 months old”, “Duplicate within same report period”); and a status of the disposition of the SLA credit request 148. Exemplary statuses for a SLA credit request 148 may include: an “In Review” status indicative of a SLA credit request 148 to be processed by the SLA verification device 140; a “Valid” status indicative of a SLA credit request 148 that has been determined to require a credit to the customer; a “Not Eligible” status indicative of a SLA credit request 148 that has been determined not to require a credit to the customer; a “Sent to Billing” status indicative of a SLA credit request 148 sent to billing for crediting back to the customer; and a “Credit” status indicative of SLA credit request 148 that has been credited back to the customer.

Exemplary fields relating to the timing of the disposition of the SLA credit request 148 may include: a date when the SLA credit request 148 was received, a date when the SLA credit request 148 was assigned a unique tracking number, a date the SLA credit request 148 was assigned for review, a date the SLA credit request 148 was verified, a date the customer was notified of the disposition of the SLA credit request 148, a date when the SLA credit request 148 was closed, and a date that the SLA credit request 148 was included in a report. These timing fields may be used by the system to ensure that verification of SLA credit request 148 is being be performed in a timely manner, such as within a certain number of billing cycles of receipt of the SLA credit requests 148.

Exemplary fields related to amount of credit owed to the customer according to the SLA credit request 148 may include: an invoice date during which the customer was originally charged or to be charged, a credit amount to be credited back to the customer, and an invoice adjust date when the invoice amount is credited by the credit amount. These fields may be used by billing sources (e.g., billing information server 120) to provide billing information relating to any credits to which the customers may be entitled.

Accordingly, by way of the various fields of the SLA credit request 148, the system 100 may receive data from completely unrelated and previously uncoupled various sources, including issue tracking databases (e.g., ticket information server 110) as well as billing databases (e.g., billing information server 120), and may verify the data from the various sources to facilitate the processing of the SLA credit request 148.

Moreover, the processing of SLA credit requests 148 may include the identification of redundant SLA credit requests 148. As an example, if a customer requests a SO credit, a TTR credit, and a SS credit for the same timeframe, at least two (if not all three) of these SLA credit requests 148 may be denied. The processing of SLA credit requests 148 may also include the rejection of inappropriate SLA credit requests 148, such as: SLA credit requests 148 that are outside the SLA contract, SLA credit requests 148 that are not billed for the month the incident took place, or SLA credit requests 148 made before or after the proper time period. The processing of SLA credit requests 148 may further include the rejection of SLA credit requests 148 that indicate issues that are within the terms of the customer's SLA. When a SLA credit request 148 is denied, the SLA verification device 140 may be configured to provide a reason to the customer for the denial.

In general, computing systems and/or devices such as the ticket information server 110, billing information server 120, customer device 130 and SLA verification device 140 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Computing devices, the ticket information server 110, billing information server 120, customer device 130 and SLA verification device 140, may generally include computer-executable instructions that may be executable by one or more processors. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor (e.g., processors 112, 122, 132, and 142) receives instructions, e.g., from a memory or a computer-readable medium (e.g., memory 114, 124, 134, and 144), etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computing device). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, such as the ticket information server 110, billing information server 120 and SLA verification device 140 may include various kinds of mechanisms for storing, accessing, and retrieving various kinds of data, including a hierarchical database, a set of files in a file system, an application database in a proprietary format, a relational database management system (RDBMS), etc. (e.g., by way of database application 116, database application 126 or SLA credit processing application 146). Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. In some examples, the application software products (e.g., the database application 116, database application 126, SLA credit reporting application 136, and SLA credit processing application 146) may be provided as software that when executed by processors of the devices and servers (e.g., processors 112, 122, 132, and 142) provides the operations described herein. Alternatively, the application software product may be provided as hardware or firmware, or combinations of software, hardware and/or firmware.

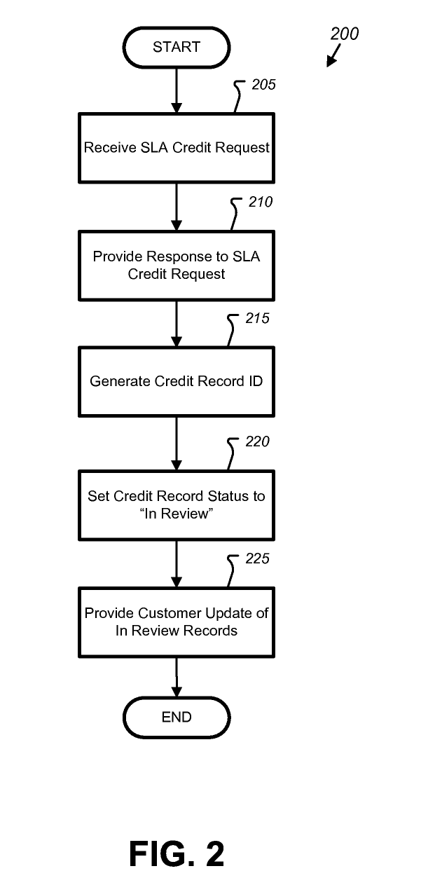

FIG. 2 illustrates an exemplary process 200 for receiving SLA credit requests 148. The process 200 may be performed by various devices, such as by a SLA verification device 140 in communication with a customer device 130 over a communications network 102.

In block 205, the SLA verification device 140 receives a SLA credit request 148 from a customer requesting a billing credit. For instance, the SLA verification device 140 may receive the SLA credit requests 148 from the customer device 130 over the communications network 102. The SLA credit request 148 may include information such as: submitter contact information (e.g., submitter name, submitter phone number, submitter e-mail address); SLA identifier; type of SLA credit request 148 (e.g., SO type, TTR type, OTP type, SS type). The SLA credit request 148 may include additional information according to the type of SLA credit request 148, such as a trouble ticket number for a TTR or SO SLA credit request 148; an order number for an OTP SLA credit request 148; and a service type, a bureau/agency and a reporting month for a SS SLA credit request 148.

In some examples, the SLA credit request 148 may be received by the SLA verification device 140 via e-mail. For instance, the SLA verification device 140 may receive an e-mail message addressed to an e-mail account configured to receive the SLA credit requests 148. The received e-mail message may be generated by the customer according to a form configured to include fields corresponding to the details of the SLA credit request 148. The form may be made available to the SLA credit reporting application 136 of the customer device 130 by the service provider or the SLA verification device 140. In some cases, multiple forms of information may be submitted as part of a single SLA credit request 148, e.g., as multiple attachments to a single e-mail message.

In block 210, the SLA verification device 140 optionally provides an automated response to the submitter of the SLA credit request 148. For example, an automated response may include verbiage such as:
We have received your Service Level Agreement (SLA) Credit Request (CR) inquiry. You will be contacted by [Service Provider] Compliance Office within 5 business days with CR tracking numbers and a status update of the your request. If this is a general question in regards to your SLA Credit request, we will respond back to you as soon as possible. Thank you.

In block 215, the SLA verification device 140 generates a SLA credit request 148 record identifier for the SLA credit request 148. For example, the SLA verification device 140 may create a new SLA credit request 148 record in a database of SLA credit requests 148 to be processed. The SLA credit request 148 record may be assigned a unique identifier to facilitate issue tracking. The SLA verification device 140 may further update a field in the SLA credit request 148 to indicate when the SLA credit request 148 was assigned the identifier.

In block 220, the SLA verification device 140 sets the status of the SLA credit request 148 record to “In Review.” By setting the status to “In Review,” the SLA verification device 140 may mark the associated SLA credit request 148 as ready for processing by the SLA verification device 140. In some cases, the verification of the SLA credit request 148 may be set to be performed within a certain number of billing cycles of receipt of the SLA credit requests 148. For instance, the verification of the SLA credit request 148 may be scheduled to be performed within two billing cycles of receipt of the SLA credit request 148. To track compliance with timeliness of assignment of the SLA credit request 148, the SLA verification device 140 may further update a field in the SLA credit request 148 to indicate when the SLA credit request 148 was set with a status of “In Review.”

In block 225, the SLA verification device 140 optionally provides the customer with an update of the SLA credit requests 148 that have a status of “In Review.” For example, the SLA verification device 140 may filter on the customer records with a disposition of “In Review” in the database, and may export the records with their associated SLA credit request 148 identifiers to the customer. Exemplary report formats for the “In Review” SLA credit requests 148 may include an Excel file report, an HTML table, a PDF file, or a plain text file. In some examples, block 225 is periodically executed to provide the customer with updates of the customer's issues. For instance, a weekly report of “In Review” SLA credit requests 148 may be sent to the customer. Exemplary reports are discussed in further detail below. After block 225, the process 200 ends.

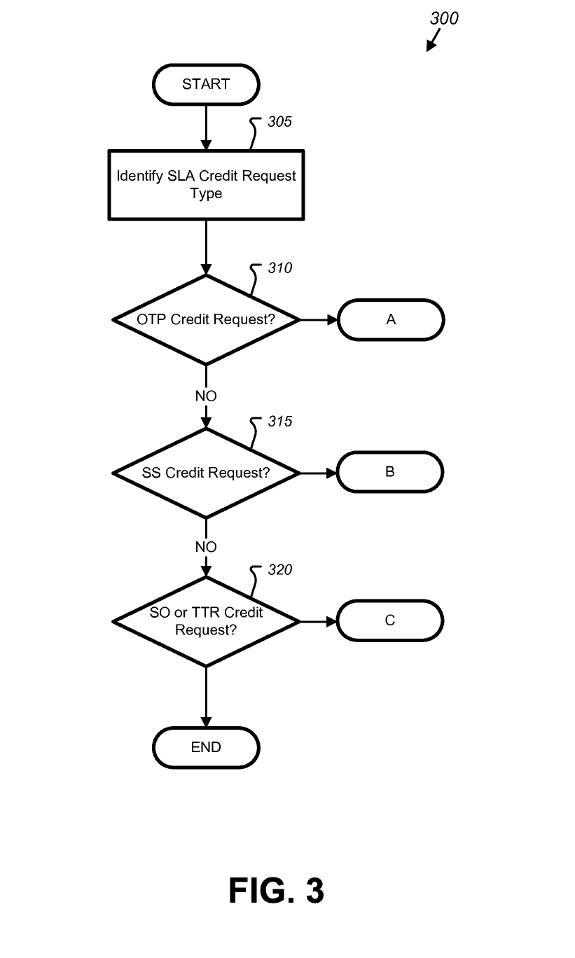

FIG. 3 illustrates an exemplary process for identifying a type of SLA credit request 148 for validation. As with the process 200, the process 300 may be performed by various devices, such as by a SLA verification device 140 in communication with a customer device 130 over a communications network 102.

In block 305, the SLA verification device 140 identifies the type of SLA credit request 148. For example, the SLA verification device 140 may review a credit type field of the SLA credit request 148 indicative of the type of SLA credit request 148.

In decision point 310, based on the credit type field, the SLA verification device 140 determines whether the SLA credit request 148 is an OTP SLA credit request 148. If the SLA credit request 148 indicates an OTP SLA credit request 148, control passes to block 405 of process 400. Otherwise, control passes to decision point 315.

In decision point 315, based on the credit type field, the SLA verification device 140 determines whether the SLA credit request 148 is an SS SLA credit request 148. If the SLA credit request 148 indicates an SS SLA credit request 148, control passes to block 505 of process 500. Otherwise, control passes to decision point 320.

In decision point 320, based on the credit type field, the SLA verification device 140 determines whether the SLA credit request 148 is an SO or TTR SLA credit request 148. If the SLA credit request 148 indicates an SO or TTR SLA credit request 148, control passes to block 605 of process 600. Otherwise, the process 300 ends.

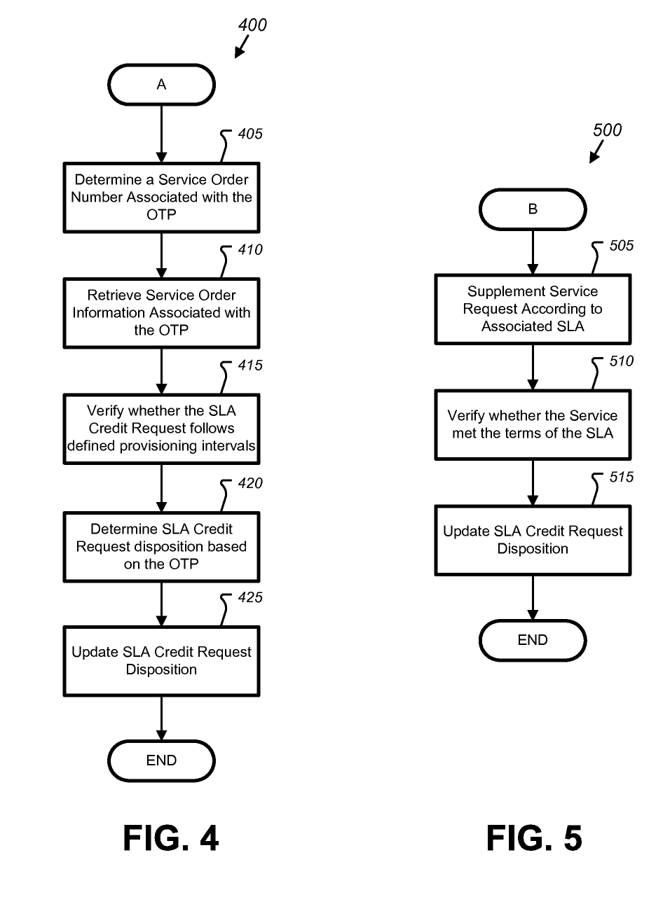

FIG. 4 illustrates an exemplary process 400 for validating OTP SLA credit requests 148. As with the processes 200 and 300, the process 400 may be performed by various devices, such as by a SLA verification device 140 in communication with a customer device 130 over a communications network 102.

In block 405, the SLA verification device 140 determines a service order number associated with the provisioning of the OTP SLA credit requests 148. For example, the SLA verification device 140 may review a service order number included in the OTP SLA credit request 148. As another example, the SLA verification device 140 may determine, according to project management information associated with the customer, that the OTP SLA credit requests 148 is associated with a particular service order of the customer. This may be accomplished by querying a service request order database or the billing information server 120 for service orders requested by the customer as indicated in the customer field of the SLA credit request 148. The SLA verification device 140 may thereby identify a number of a matching service request order.

In block 410, the SLA verification device 140 retrieves service order information associated with the OTP SLA credit request 148. For example, the SLA verification device 140 may provide the service order number to an ordering application or to the billing information server 120. The SLA verification device 140 may accordingly retrieve information such as: an agency name associated with the service order; a service name associated with the service order number; whether the service order is a routine or an expedited service order; a confirmation date of the service order; a completion data of the service order; an order type; and a SLA number associated with the service order (e.g., SLA contract number). The SLA verification device 140 may also retrieve additional data from the service order, such as location information (e.g., whether the order is international, within the continental United States, or outside the continental United States) and affected line information (e.g., circuit identifiers related to the service order). In some examples, the retrieved information may be added to the OTP SLA credit request 148 to supplement and aid in verification of the request.

In block 415, the SLA verification device 140 verifies whether the OTP SLA credit request 148 follows the defined provisioning intervals for the service order. For example, based on various factors, the SLA verification device 140 may determine a time by which the service order should have been completed. These factors may include one or more of: the location of the service order (e.g., International, continental U.S., outside continental U.S.); whether the order is routine or expedited; and the type of service being ordered, altered, or discontinued. In some cases, the SLA verification device 140 may determine a time by which the order should be completed according to a firm order commitment date agreed to by the service provider.

In block 420, the SLA verification device 140 determines a disposition of the service order according to the provisioning intervals for the service order. For example, the SLA verification device 140 may compare reported outage time from the OTP SLA credit request 148 with the provisioning intervals for the service order in order to determine whether the outage time should be credited to the customer. For example, if the reported outage occurs after the service order should have been completed, then the customer may be entitled to a credit; however, if the reported outage occurs within the provisioning interval then the OTP SLA credit request 148 may be denied.

In block 425, the SLA verification device 140 updates the status of the disposition of the OTP SLA credit request 148 according to the determination. For example, if the SLA verification device 140 determines that the customer is entitled to a refund, the SLA verification device 140 may set the status of the disposition of the SLA credit request 148 to “Valid.” Otherwise, the SLA verification device 140 may set the status of the disposition to “Not Eligible.” After block 425, the process 400 ends.

FIG. 5 illustrates an exemplary process 500 for validating SS SLA credit requests 148. As with the processes 200, 300 and 400, the process 500 may be performed by various devices, such as by a SLA verification device 140 in communication with a customer device 130 over a communications network 102.

In block 505, the SLA verification device 140 supplements information in the SS SLA credit request 148. For example, the SLA verification device 140 may retrieve information based on a service name of the SS SLA credit request 148 to add to the SS SLA credit request 148. This information may be retrieved from various sources, such as from the billing information server 120. This supplemental information may include, for example: an agency or bureau name associated with the service; a SLA number associated with the service; a year and month of completion of the service as specified by the SLA; and whether the service order is a routine or critical service.

In block 510, the SLA verification device 140 verifies whether the SS SLA credit request 148 is a valid request according to the terms of the identified SLA. For example, the SLA verification device 140 may verify that the service name of the SS SLA credit request 148 is actually covered by the identified SLA. As another example, the SLA verification device 140 may verify whether the service was actually completed within a timeframe specified in the SLA.

In block 515, the SLA verification device 140 updates the status of the disposition of the SS SLA credit request 148 according to the determination. For example, if the SLA verification device 140 determines that the customer is entitled to a refund, the SLA verification device 140 may set the status of the disposition of the SLA credit request 148 to “Valid.” Otherwise, the SLA verification device 140 may set the status of the disposition to “Not Eligible.” After block 515, the process 500 ends.

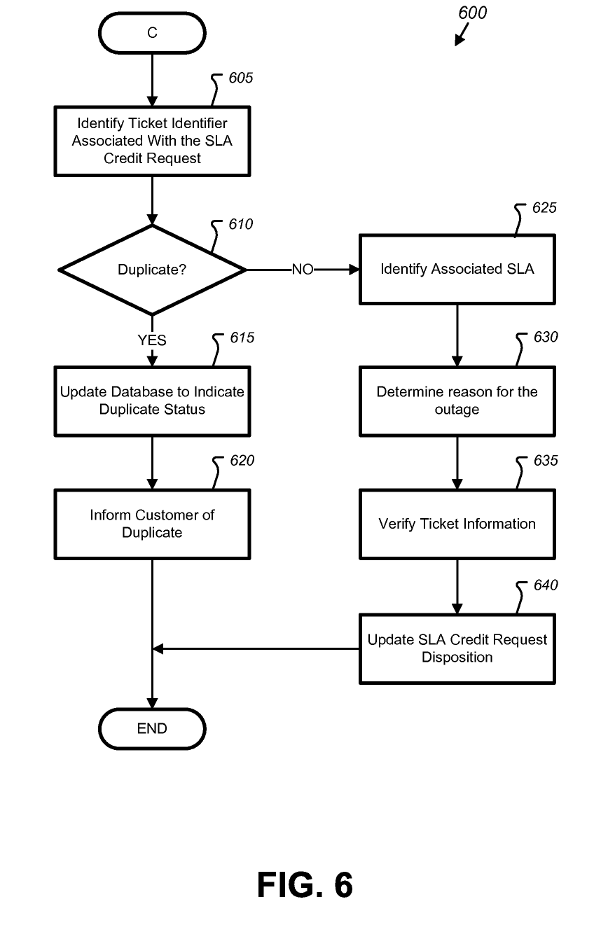

FIG. 6 illustrates an exemplary process 600 for validating SO and TTR SLA credit requests 148. As with the processes 200, 300, 400 and 500, the process 600 may be performed by various devices, such as by a SLA verification device 140 in communication with a customer device 130 over a communications network 102.

In block 605, the SLA verification device 140 identifies a ticket identifier associated with the SLA credit request 148. For example, the SLA verification device 140 may retrieve a ticket identifier of an incident from the fields of the SLA credit request 148 submitted by a customer.

In decision point 610, the SLA verification device 140 determines whether the SLA credit request 148 is a duplicate. For example, the SLA verification device 140 may perform a duplicate issue number check by comparing the ticket number associated with the SLA credit request 148 with the ticket numbers associated with the other SLA credit requests 148 stored by the SLA verification device 140. If another SLA credit request 148 references the same issue number, then the SLA credit request 148 may be determined to be a duplicate. As another example, the SLA verification device 140 may perform a duplicate issue number check by searching for tickets in the ticket information system 110 that are associated with other aspects of the SLA credit request 148, such as customer and timeframe. If another SLA credit request 148 references an issue in the ticket information system 110 that are associated with the same aspects (e.g., same customer and timeframe), then the SLA credit request 148 may be determined to be a duplicate. If the SLA verification device 140 identifies a duplicate SLA credit request 148, control passes to block 615. Otherwise, control passes to block 625.

In block 615, the SLA verification device 140 updates the SLA credit request 148 to indicate that it is a duplicate. For example, the SLA verification device 140 may set the status of the SLA credit request 148 to “Not Eligible.” The SLA verification device 140 may also indicate in other fields of the SLA credit request 148 that the SLA credit request 148 is a duplicate. For example, the SLA verification device 140 may update a justification field of the SLA credit request 148 to indicate that the SLA credit request 148 has a duplicate trouble ticket number. As another example, the SLA verification device 140 may update a notes field of the SLA credit request 148 to indicate an identifier of the duplicate ticket or SLA credit request 148. In some cases, the SLA verification device 140 may query the ticket information server 110 for further information with respect to the ticket and the duplicate ticket to provide to the customer.

In block 620, the SLA verification device 140 optionally informs the customer of the duplicate SLA credit request 148. For example, the SLA verification device 140 may send the customer an e-mail or other message indicating that the submitted SLA credit request 148 is a duplicate. The message may further indicate an identifier of the duplicate ticket or SLA credit request 148. After block 620, the process 600 ends.

In block 625, the SLA verification device 140 identifies a SLA associated with the SLA credit request 148. For example, the SLA verification device 140 may determine the appropriate SLA according to a field in the SLA credit request 148 including an identifier of a SLA. As another example, the SLA verification device 140 may determine the appropriate SLA according to the customer. As yet another example, the SLA verification device 140 may identify a base generic SLA for SLA credit requests 148 that do not specify a customer SLA.

In block 630, the SLA verification device 140 determines a reason for the outage indicated by the SLA credit request 148. For example, the SLA credit request 148 may include a reason for the outage as represented by the customer. As another example, the SLA credit request 148 may review a telecommunications service priority (TSP) code associated with the SLA credit request 148. The TSP code may indicate, for example, a priority of a circuit outage (e.g., circuit down hard; circuit bouncing) or another reason for the outage.

In block 635, the SLA verification device 140 verifies ticket information associated with the SLA credit request 148 based on the outage reason. For example, the SLA verification device 140 may validate fields of the SLA credit request 148 to determine whether the SLA credit request 148 is associated with the indicated outage. As some examples, the SLA verification device 140 may verify fields of the SLA credit request 148 such as: circuit identifier, ticket open date and time, ticket close date and time, outage time, priority, outage cause, resolution description, and resolution code.

In block 640, the SLA verification device 140 updates the status of the disposition of the SLA credit request 148 according to the validation. For example, if the SLA verification device 140 determines that the outage is consistent with the issue or trouble ticket associated with the SLA credit request 148, the SLA verification device 140 may set the status of the disposition of the SLA credit request 148 to “Valid.” Otherwise, the SLA verification device 140 may set the status of the disposition to “Not Eligible.” After block 640, the process 600 ends.

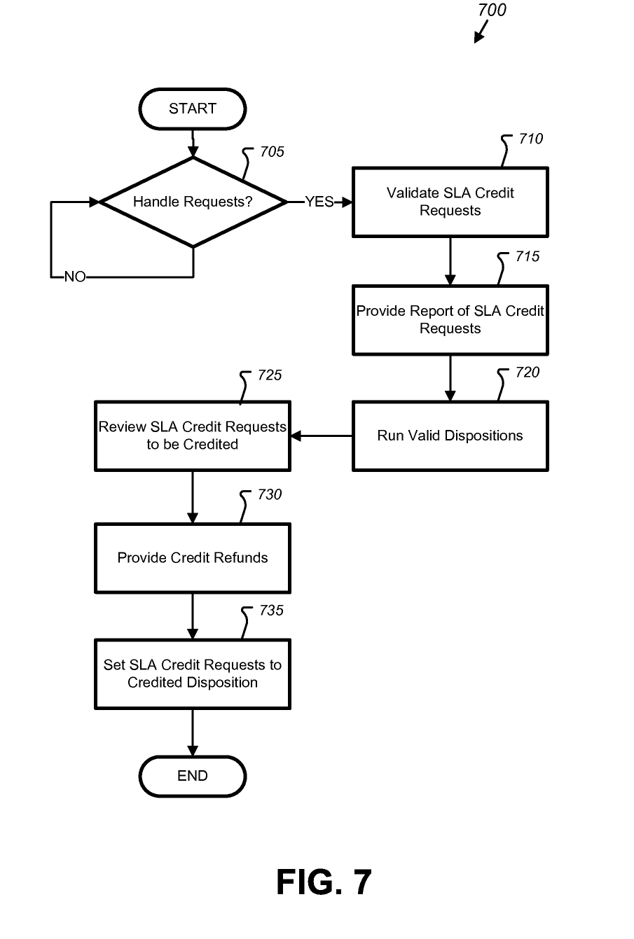

FIG. 7 illustrates an exemplary process for providing credit refunds to customers based on validated SLA credit requests. As with the processes 200, 300, 400, 500 and 600, the process 700 may be performed by various devices, such as by a SLA verification device 140 in communication with a customer device 130 over a communications network 102.

In decision point 705, the SLA verification device 140 determines whether to process the SLA credit requests 148. For example, the SLA verification device 140 may retrieve and process the SLA credit requests 148 in batches, and may automatically process the SLA credit requests 148 periodically (e.g., daily) or upon receipt of a sufficient number of requests SLA credit requests 148. In other examples, the SLA verification device 140 may retrieve and automatically process received SLA credit requests 148 substantially as they are received. If SLA credit requests 148 are retrieved for processing, control passes to block 710. Otherwise, control remains at decision point 705.

In block 710, the SLA verification device 140 validates the SLA credit requests 148. For example, the SLA verification device 140 may automatically act on the SLA credit requests 148 by performing validations such as those discussed above with respect to processes 300, 400, 500 and 600. The SLA verification device 140 may further update a field in the SLA credit request 148 to indicate when the SLA credit request 148 was validated.

In block 715, the SLA verification device 140 provides a report to the customer of the status of the customer's SLA credit requests 148. For example, the SLA verification device 140 may query the SLA credit requests 148 by customer, and may send the customer a report based on the results. The report may further include the status or disposition of each of the SLA credit requests 148, e.g., which SLA credit requests 148 are “In Review,” which are “Valid,” and which are “Not Eligible.” In some examples, the report is provided to the customer periodically, such as weekly, to allow the customer to track the status of its SLA credit requests 148. Exemplary formats for the report may include as Excel spreadsheet, an HTML table, a PDF file, or a plain text file. Certain exemplary reports are discussed in further detail below. The SLA verification device 140 may further update a field in the SLA credit request 148 to indicate when the SLA credit request 148 was included in a report to the customer.

In block 720, the SLA verification device 140 runs valid dispositions through billing. For example, the SLA verification device 140 may query the SLA credit requests 148 to identify those SLA credit requests 148 determined to be of “Valid” disposition. These “Valid” SLA credit requests 148 may be assigned a disposition of “Sent to Billing,” and may further be assigned a date at which they are assigned to be “Sent to Billing.” To facilitate running the valid dispositions, the billing information server 120 or the SLA verification device 140 may perform a query of SLA credit requests 148 having a disposition of “Sent to Billing,” where the resulting SLA credit requests 148 are those that are ready to have credit amounts and invoice adjusted dates assigned to them. In some cases, these resulting SLA credit requests 148 may be sent or otherwise made available to the billing information server 120 for an automated determination of the credit amounts and invoice adjusted dates by the billing information server 120. In other cases, the SLA verification device 140 may perform the automated determinations of the credit amounts and invoice adjusted dates by querying the billing information server 120 for information sufficient to make the determination. With respect to the disposition, the amount of the credit may be determined based on information such as the amount of time of the outage and terms of the SLA, as some examples. The amount of time of the outage may be determined, for example, by querying the ticket information server 110 for ticket information 118 corresponding to the SLA credit request 148. An appropriate invoice adjusted date may be determined based on the SLA, or in other cases the next invoice may be credited with the credit amount.

In block 725, the SLA verification device 140 reviews the SLA credit requests 148 to be credited. For example, the SLA verification device 140 may identify the populated credit amounts and invoice adjusted dates for each “Sent to Billing” SLA credit request 148. Accordingly the SLA credit requests 148 may be populated according to both issue tracking and also completely unrelated and previously uncoupled billing database sources.

In block 730, the SLA verification device 140 provides credit refunds to the customer. For example, the SLA verification device 140 may send the credit amounts to the billing information server 120 to be credited to the customer's invoice. In other examples, the billing information server 120 may instead provide the credit amounts, which may be used by the SLA verification device 140 to update the SLA credit requests 148.

In block 735, the SLA verification device 140 sets the disposition of the SLA credit requests 148 to a “Credited” disposition. After block 735, process 700 ends. In other examples, control passes to block 715 from block 735 to provide an updated report to the customer. In yet other examples, control passes to block 705 to process further SLA credit request 148.

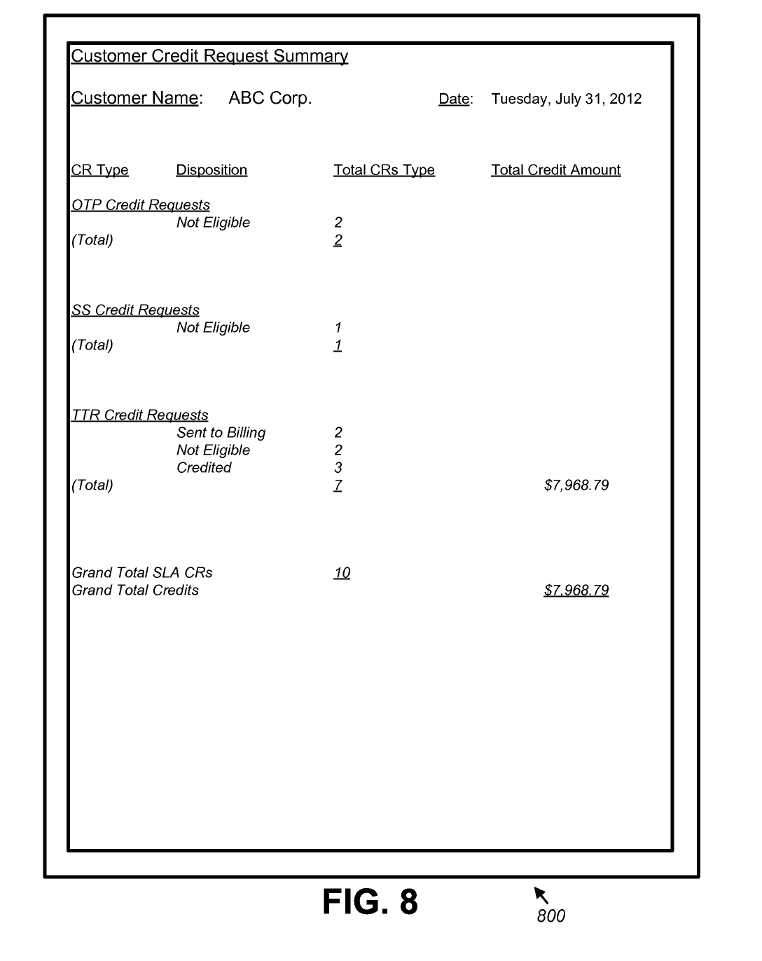

FIG. 8 illustrates an exemplary customer SLA credit request report 800. The SLA verification device 140 may provide a report, such as the exemplary SLA credit request report 800, to the customer to inform the customer of the status of the customer's SLA credit requests 148. The SLA credit request report 800 may include information for the customer, such as a listing of SLA credit requests 148 according to status or disposition. For example, the SLA credit request report 800 may indicate how many SLA credit requests 148 are Open (e.g., “Sent to Billing,” “In Review”) and Closed (e.g., “Not Eligible,” “Credited”). In some cases, the determination may be made according to a field of the SLA credit requests 148 indicative of whether the issues are “Open” or “Closed”, while in other cases the determination may be made according to the statuses of the SLA credit requests 148. The SLA credit request report 800 may further include information with respect to the SLA credit requests 148 over the most recent period. For example, for a weekly-generated report 800, the SLA credit request report 800 may further provide a status of the SLA credit requests 148 received over the past week. As some examples, the SLA credit request report 800 may be provided to a customer periodically, such as by way of block 715 of the process 700, as part of receipt of customer-reported SLA credit requests 148 such as by way of block 225 of process 200, or to management such as after completion of the process 700. Timing information regarding the periods may be determined from various fields of the SLA credit requests 148 related to the timing of the disposition of the SLA credit request 148.

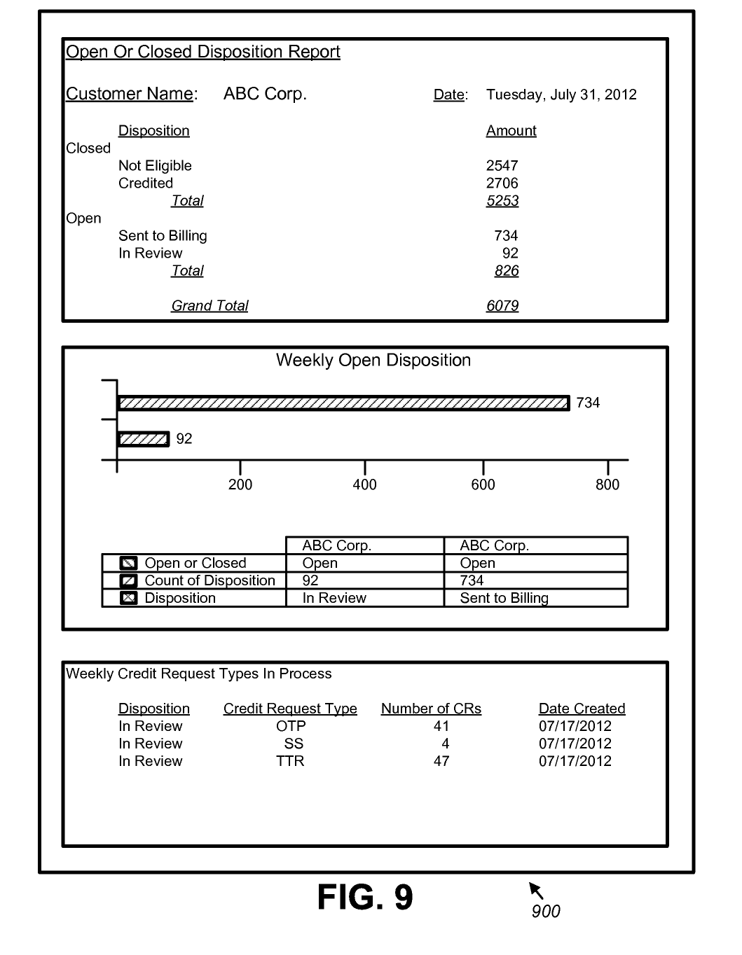

FIG. 9 illustrates an exemplary disposition SLA credit request summary report 900. The SLA verification device 140 may provide a disposition SLA credit request report 900 to a customer or to management of a service provider to provide visibility into the customer SLA credit requests 148. The disposition SLA credit request report 900 may include useful information such as a listing of the amount of overall SLA credit requests 148 according to status or disposition, such as how many SLA credit requests 148 are Open (e.g., “Sent to Billing,” “In Review”) and Closed (e.g., “Not Eligible,” “Credited”). The disposition SLA credit request report 900 may further include information with respect to the SLA credit requests 148 over the most recent period. For example, for weekly-generated reports 900, the disposition SLA credit request report 900 may provide a status of the SLA credit requests 148 received over the past week. The SLA credit request report 800 may also be provided to a customer periodically, such as by way of block 715 of the process 700, as part of receipt of customer-reported SLA credit requests 148 such as by way of block 225 of process 200, or to management such as after completion of the process 700. As mentioned above, timing information regarding the periods may be determined from various fields of the SLA credit requests 148 related to the timing of the disposition of the SLA credit request 148.

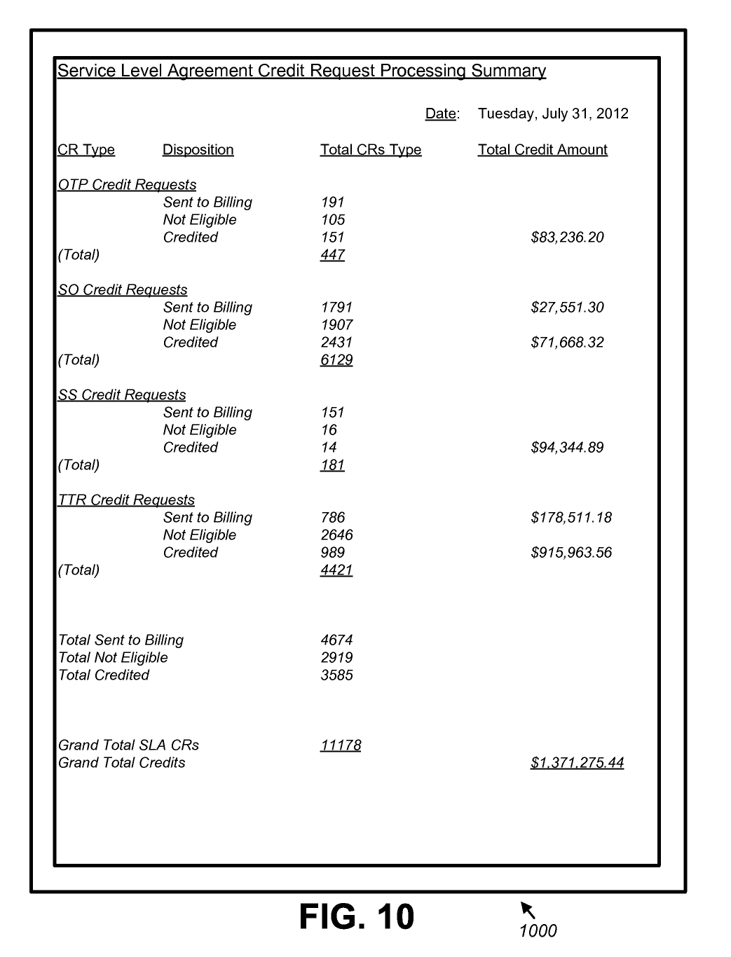

FIG. 10 illustrates an exemplary SLA credit request 148 processing summary report 1000. As opposed to the reports 800 and 900, the SLA credit request 148 processing summary report 1000 may provide a status of the SLA credit request 148 overall, rather than the SLA credit requests 148 of a particular customer or agency. The SLA credit request 148 processing summary report 1000 may include information useful to management of a service provider. This information may include a total number of SLA credit requests 148 broken down according to request type, and then for each request type, a breakdown of the status or dispositions of the SLA credit requests 148 and credit amounts given to the customers.

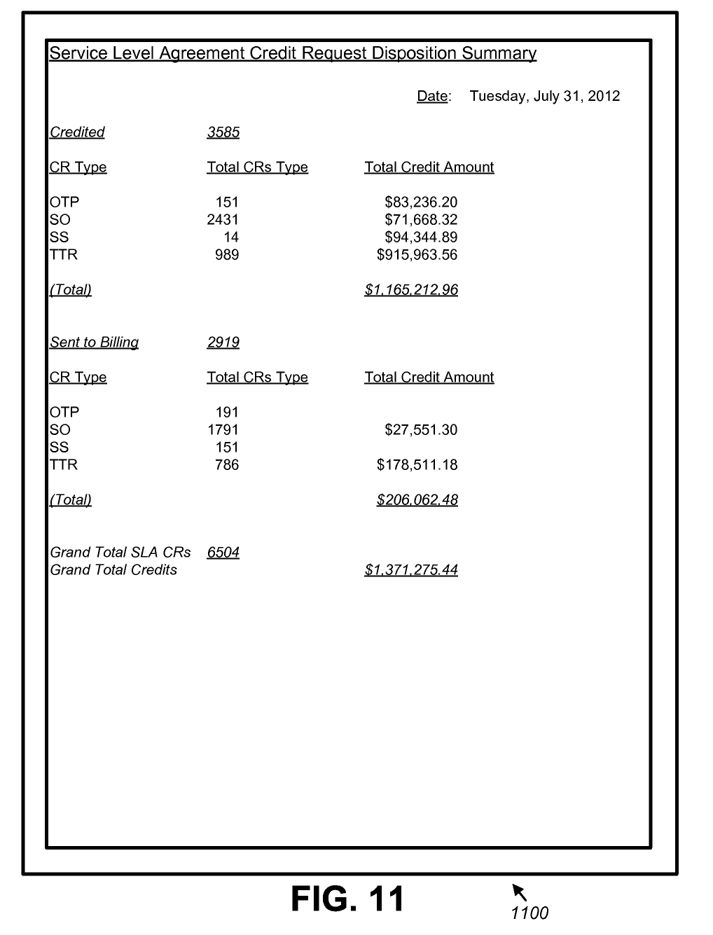

FIG. 11 illustrates an exemplary SLA credit request 148 disposition summary report 1100. Similar to the summary report 1000, SLA credit request 148 disposition summary report 1100 may provide a status of the SLA credit request 148 overall, rather than the SLA credit requests 148 of a particular customer or agency. The SLA credit request 148 disposition summary report 1100 may include a breakdown of the SLA credit requests 148 according to disposition, and then for each type of disposition, a breakdown of the SLA credit requests 148 according to request type and credit amount. Thus, the summary reports 1000 and 1100 may provide similar information, but pivoted or organized according to different perspective.

Accordingly, a system such as the exemplary system 100 may be configured to utilize processes 300, 400, 500, 600 and 700 to automate processing of billing issues related to customer-reported SLA credit requests 148. Using a process such as the process 200 discussed above with respect to FIG. 2, a SLA verification device 140 may be configured to receive SLA credit requests 148 for billing credits. The submitted SLA credit requests 148 may be based on perceived issues with the billing for provided communications services relating to the terms defined in a SLA associated with the customer. The SLA verification device 140 may further utilize process 200 or the like to provide information to the submitter regarding submitted SLA credit requests 148, such as the exemplary customer SLA credit request report 800 described with respect to FIG. 8 or the exemplary disposition SLA credit request summary report 900 described with respect to FIG. 9. As discussed in FIG. 3 with respect to process 300, the SLA verification device 140 may be configured to identify a type of the SLA credit requests 148. Moreover, as discussed in FIGS. 4-6 with respect to process 400, 500 and 600, the SLA verification device 140 may be configured to validate the service level agreement credit request based on the type of the service level agreement credit request and update a disposition of the SLA credit request 148 based on a result of the validation. The SLA verification device 140 may perform the validation using data from various sources, including the ticket information server 110 and the billing information server 120 as some examples. Using a process such as the process 700 described in detail with respect to FIG. 7, the SLA verification device 140 may selectively provide credit refunds to customers according to both issue tracking and also completely unrelated and previously uncoupled billing database sources based on the validated SLA credit requests 148. The SLA verification device 140 may further utilize the process 700 or the like to provide reports to management of the service provider with respect to the status of the SLA credit requests 148 and associated billing, such as the exemplary SLA credit request 148 processing summary report 1000 described with respect to FIG. 10 or the SLA credit request 148 disposition summary report 1100 described with respect to FIG. 11. The SLA verification device 140 may further record the timing of certain actions, such as issue receipt, verification and reporting, to facilitate ensuring that the verification of SLA credit request 148 is being be performed in a timely manner, such as within a certain number of billing cycles of receipt of the SLA credit requests 148.

Moreover, variations on the aforementioned systems and methods are possible. For example, the operations of the SLA verification device 140 may be performed by multiple computing devices that each performs a subset of the steps exemplary processes. As another example, the system may include a plurality of SLA verification devices 140 that each performs handling of only a subset of the SLA credit requests 148 (e.g., for load-balancing, or where different SLA verification devices 140 handle different types SLA credit requests 148). As further examples, one or more of the elements of system 100 may be combined together, or additional elements may be included in the system 100 such as additional data stores of information to use to validate the SLA credit requests 148.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system, comprising:
a service level agreement validation device including a memory and service level agreement credit processing application installed thereon, wherein the service level agreement credit processing application is configured to cause the service level agreement validation device to, upon receiving a service level agreement credit request from a customer:
identify a type of the service level agreement credit request;
validate the service level agreement credit request based on the type of the service level agreement credit request;
update a disposition of the service level agreement credit request based on a result of the validation; and
provide a credit to the customer based on the disposition of the service level agreement credit request.

2. The system of claim 1, wherein the service level agreement validation device is further configured to cause the service level agreement validation device to provide a report to the customer, the report including a listing of service level agreement credit requests of the customer, the listing including a status of each of the listed service level agreement credit requests of the customer.

3. The system of claim 1, wherein the service level agreement validation device is further configured to cause the service level agreement validation device to:
identify the service level agreement credit request as an on-time provisioning service level agreement credit request;
determine a service order associated with on-time provisioning;
retrieve service order information associated with the service order;
verify whether the service level agreement credit request follows provisioning intervals of the service order information of the on-time provisioning; and
determine the disposition of the on-time provisioning service level agreement credit request according to the verification of the provisioning intervals.

4. The system of claim 1, wherein the service level agreement validation device is further configured to cause the service level agreement validation device to:
identify the service level agreement credit request as a service-specific service level agreement credit request according to a service name associated with the service-specific service level agreement credit request;
supplement the service-specific service level agreement credit request according to terms specified by a service level agreement for the service name;
verify whether the service met the terms of the service level agreement; and
determine the disposition of an on-time provisioning service level agreement credit request according to the verification of the service.

5. The system of claim 1, wherein the service level agreement validation device is further configured to cause the service level agreement validation device to:
identify the service level agreement credit request as a time-to-restore service level agreement credit request;
identify a ticket identifier associated with the service level agreement credit request;
identify a service level agreement associated with the service level agreement credit request;
determine an outage reason for the service level agreement credit request;
verify ticket information of the service level agreement credit request based on the outage reason and the service level agreement; and
determine the disposition of the provisioning service level agreement credit request according to the verification of the ticket information.

6. The system of claim 1, wherein the service level agreement validation device is further configured to cause the service level agreement validation device to:
identify a ticket identifier associated with the service level agreement credit request;
determine whether the service level agreement credit request is a duplicate; and
determine the disposition of the provisioning service level agreement credit request based at least in part on the whether the service level agreement credit request is a duplicate.

7. (canceled)

8. A method, comprising:
identifying, by a service level agreement validation device, a type of service level agreement credit request received from a customer, wherein the service level agreement validation device includes a processor and memory;
validating, by a service level agreement validation device, the service level agreement credit request based on the type of the service level agreement credit request;
updating, by a service level agreement validation device, a disposition of the service level agreement credit request based on result of the validation; and
providing a credit to the customer, by the service level agreement validation device, based on the disposition of the service level agreement credit request.

9. The method of claim 8, further comprising providing a report to the customer, the report including a listing of service level agreement credit requests of the customer, the listing including a status of each of the listed service level agreement credit requests of the customer.

10. The method of claim 8, further comprising:
identifying the service level agreement credit request as an on-time provisioning service level agreement credit request;
determining a service order associated with on-time provisioning;
retrieving service order information associated with the service order;
verifying whether the service level agreement credit request follows the provisioning intervals of the service order information of the on-time provisioning; and
determining the disposition of the on-time provisioning service level agreement credit request according to the verification of the provisioning intervals.

11. The method of claim 8, further comprising:
identifying the service level agreement credit request as a service-specific service level agreement credit request according to service name associated with the service-specific service level agreement credit request;
supplementing the service-specific service level agreement credit request according to terms specified by a service level agreement for the service name;
verifying whether the service met the terms of the service level agreement; and
determining the disposition of on-time provisioning service level agreement credit request according to the verification of the service.

12. The method of claim 8, further comprising:
identifying the service level agreement credit request as a time-to-restore service level agreement credit request;
identifying a ticket identifier associated with the service level agreement credit request;
identifying a service level agreement associated with the service level agreement credit request;
determining an outage reason for the service level agreement credit request;
verifying ticket information of the service level agreement credit request based on the outage reason and the service level agreement; and
determining the disposition of the provisioning service level agreement credit request according to the verification of the ticket information.

13. The method of claim 8, further comprising:
identifying a ticket identifier associated with the service level agreement credit request;
determining whether the service level agreement credit request is a duplicate; and
determining the disposition of the provisioning service level agreement credit request based at least in part on the whether the service level agreement credit request is a duplicate.

14. (canceled)

15. A non-transitory computer readable medium storing a service level agreement credit processing application software program, the service level agreement credit processing application being executable by a service level agreement validation device to provide operations comprising:
identifying a type of a service level agreement credit request received from a customer;
validating, by a service level agreement validation device, the service level agreement credit request based on the type of the service level agreement credit request;
updating a disposition of the service level agreement credit request based on result of the validation; and
providing a credit to the customer, by the service level agreement validation device, based on the disposition of the service level agreement credit request.

16. The non-transitory computer readable medium of claim 15, further providing for operations comprising providing a report to the customer, the report including a listing of service level agreement credit requests of the customer, the listing including a status of each of the listed service level agreement credit requests of the customer.

17. The non-transitory computer readable medium of claim 15, further providing for operations comprising:
identifying the service level agreement credit request as an on-time provisioning service level agreement credit request;
determining a service order associated with on-time provisioning;
retrieving service order information associated with the service order;
verifying whether the service level agreement credit request follows provisioning intervals of the service order information of the on-time provisioning; and
determining the disposition of the on-time provisioning service level agreement credit request according to the verification of the provisioning intervals.

18. The non-transitory computer readable medium of claim 15, further providing for operations comprising:
identifying the service level agreement credit request as a service-specific service level agreement credit request according to service name associated with the service-specific service level agreement credit request;
supplementing the service-specific service level agreement credit request according to terms specified by a service level agreement for the service name;
verifying whether the service met the terms of the service level agreement; and
determining the disposition of on-time provisioning service level agreement credit request according to the verification of the service.

19. The non-transitory computer readable medium of claim 15, further providing for operations comprising:
identifying the service level agreement credit request as a time-to-restore service level agreement credit request;
identifying a ticket identifier associated with the service level agreement credit request;
identifying a service level agreement associated with the service level agreement credit request;
determining an outage reason for the service level agreement credit request;
verifying ticket information of the service level agreement credit request based on the outage reason and the service level agreement; and
determining the disposition of the provisioning service level agreement credit request according to the verification of the ticket information.

20. The non-transitory computer readable medium of claim 15, further providing for operations comprising:
identifying a ticket identifier associated with the service level agreement credit request;
determining whether the service level agreement credit request is a duplicate; and
determining the disposition of the provisioning service level agreement credit request based at least in part on the whether the service level agreement credit request is a duplicate.

21. (canceled)

22. The system of claim 6, wherein determining whether the service level agreement credit request is a duplicate includes finding duplicate issue numbers.

23. The method of claim 13, wherein determining whether the service level agreement credit request is a duplicate includes finding duplicate timeframes.

24. The non-transitory computer readable medium of claim 20, wherein determining whether the service level agreement credit request is a duplicate includes finding duplicate customer names.
